(19) United States
(12) Patent Application Publication
(10) Pub. No.: US 2015/0001101 A1
(43) Pub. Date: Jan. 1, 2015

(54) ADSORBED NATURAL GAS STORAGE

(71) Applicant: BASF Corporation, Florham Park, NJ (US)

(72) Inventors: William Dolan, Yardley, PA (US); Michael SantaMaria, Monmouth Junction, NJ (US)

(21) Appl. No.: 14/314,453

(22) Filed: Jun. 25, 2014

Related U.S. Application Data
(60) Provisional application No. 61/840,114, filed on Jun. 27, 2013.

(51) Int. Cl. B60K 15/03; F17C 11/00; F02B 43/12; F02B 43/10

(52) U.S. Cl. CPC B60K 15/03006; F02B 43/10; F17C 11/007; F02B 43/12; F02B 2043/103; B60K 2015/03309; B60K 2015/03026
USPC 206/7

(57) ABSTRACT

The present invention is directed towards a natural gas storage system for a vehicle, comprising a guard bed, at least one valve and a primary storage vessel, wherein the filter is smaller than the vessel and contains a heating mechanism, and the valve controls pressure within the bed and the vessel.

### FIELD OF THE INVENTION

The invention relates generally to transportation vehicles or other devices fueled by natural gas or other natural gas stored at low pressure. More particularly, the invention relates to such vehicles or devices having fuel storage apparatus employing high-surface-area adsorptive materials and also to refueling apparatus for such vehicles.

### BACKGROUND OF THE INVENTION

Over the years, concerns have developed over the availability of conventional fuels (such as gasoline or diesel fuel) for internal combustion engine vehicles, the operating costs and fuel efficiencies of such vehicles, and the potentially adverse effects of vehicle emissions on the environment. Because of such concern, much emphasis has been placed on the development of alternatives to such conventional vehicle fuels. One area of such emphasis has been the development of vehicles fueled by natural gas or other methane-type natural gas, either as the sole fuel or as one fuel in a dual-fuel system. As a result, vehicles using such fuels have been produced and are currently in use both domestically and abroad.

In order to provide such natural gased vehicles with a reasonable range of travel between refuelings, it has previously been necessary to store the on-board natural gas at very high pressures, generally in the range of approximately 2000 psig (13.9 MPa) to 3000 psig (20.7 MPa). Without such high-pressure on-board storage, the practical storage capacity of such vehicles was limited because of space and weight factors to the energy equivalent of approximately one to five gallons (3.7 to 19 liters) of conventional gasoline. Thus, by compressing the natural gas to such high pressures, the on-board storage capacities of such vehicles were increased.

One disadvantage of the compressed natural gas systems discussed above is that they require complex and comparatively expensive and refueling apparatus in order to compress the fuel to such high pressures. Such refueling apparatus has been found to effectively preclude refueling the vehicle from a user's residential natural gas supply system as being commercially impractical on an individual ownership basis. Furthermore, such high pressure apparatus is frequently perceived by the public as being more dangerous than low pressure apparatus. For example, the public is already accustomed to refrigerant pressures in the area of approximately 200 psig (1380 KPa) in home refrigeration units and does not find such low pressures objectionable.

Another disadvantage of high pressure on-board natural gas storage systems is that heavy walled containers must typically be used, thereby increasing the cost and weight of the system. Additionally, as the cylinders are discharged during the operation of the vehicle, significant condensation on the cylinders and associated piping can occur as a result of the magnitude of the decrease in the pressure inside the cylinder.

Another alternative to the above discussed fuel storage and vehicle range problems, has been to store the on-board fuel in a liquid state generally at or near atmospheric pressure in order to allow sufficient quantities of fuel to be carried on board the vehicles to provide reasonable travel ranges between refuelings. Such liquefied gas storage may be disadvantageous if it involves complex and comparatively expensive cryogenic equipment, both on board the vehicle and in the refueling station, in order to establish and maintain the necessary low gas temperatures.

In U.S. Pat. Nos. 4,522,159 and 4,523,548 there is disclosed a utilization system for gaseous hydrocarbon fuel powered vehicles which stores the fuel on-board at relatively low pressures up to approximately 500 psig using sorptive storage means. The disclosed vehicle utilization system comprises means for on-board storage of a self-contained supply of the gaseous hydrocarbon fuel, a prime mover, means for conveying the gaseous hydrocarbon fuel to and from the on-board storing means and means for controlling the pressure of the gaseous hydrocarbon fuel from the on-board storing means to the prime mover. The on-board storing means is said to include one or more vessels or cylinders, containing a predetermined sorbent material for allowing a given amount of the gaseous hydrocarbon fuel to be stored at such lower pressure. The prime mover such as an internal combustion engine includes means for combining the gaseous hydrocarbon fuel with air to produce the mechanical energy therefrom necessary to move the vehicle. The conveying means is reported to be adapted so as to convey the gaseous hydrocarbon fuel to the on-board storing means from a stationary refueling apparatus, and also to convey the gaseous hydrocarbon fuel from the on-board storing means to the combining means of the prime mover during operation of the vehicle. In the preferred embodiment, the maximum pressure at which the gaseous hydrocarbon fuel is stored in the on-board storing means is the range of approximately 100 psig to approximately 400 psig.

As described in the above-mentioned patents, the power plant includes a fuel port, a storage vessel, and interposed between the fuel port and the storage vessel is a sorptive filter, which forms an important part of the invention. The sorptive filter is comprised of a vessel, which contains a predetermined sorbent material for filtering the flow of the gaseous hydrocarbon fuel to the storage vessel. The sorptive filter vessel may be any shape or construction, which is capable of withstanding the maximum pressure at which the power plant is intended to operate. However, it is generally preferred that the size of the filter vessel be related to the size of the storage vessel. Specifically, it has been found advantageous to provide at least 0.0052 cubic feet of filter capacity to each cubic feet of storage capacity. With regard to the sorbent material, it is preferred that this sorbent material be comprised of activated carbon. In this regard, both the sorbent material contained in the sorptive filter and the sorbent material contained in the storage vessel may both be comprised of activated carbon.

It should be noted that the sorptive filter is associated with the conveying means of the power plant such that the gaseous hydrocarbon fuel supplied by a stationary source thereof must first pass through the sorptive filter before being stored in the storage vessel. Likewise, before the stored gaseous hydrocarbon fuel can be conveyed to a carburetor of the power plant, this fuel must again pass through the sorptive filter. During the charging of the stored vessel, the sorptive filter adsorptively and/or absorptively removes predetermined constituents of the gaseous hydrocarbon fuel, as well as any odorent previously introduced to the fuel, before the gaseous hydrocarbon fuel is conveyed to the storage vessel. These predetermined constituents include, for example, oil, water vapor, and so-called “heavy end” constituents of the fuel. Generally speaking, such heavy end constituents include propane and other constituents that are heavier than methane. The purpose of removing such heavy end constituents is to maximize the capability of the storage vessel to sorptively store the lighter hydrocarbons, such as methane for example. It is also important to note that the sorptive filter also operates to prevent the accummulation over time of any unwanted fuel constituents in the storage vessel.

When the engine for the power plant is energized and enabled to consume the gaseous hydrocarbon fuel stored in the storage vessel, the sorptive filter operates to desorptively re-introduce the removed constituents and odorent to the flow of the gaseous hydrocarbon fuel from the storage vessel to the carburetor of the engine. Accordingly, it should be appreciated that the sorptive filter is self-cleaning during each charge and discharge cycle of the storage system.

In order to assist the desorption of the undesirable constituents from the sorbent material contained in the filter, means for increasing the temperature of the sorptive filter may also be provided in the appropriate application. Preferably, this temperature increasing means is associated with the engine of the power plant so that the heat generated by the operation of the engine is utilized by the temperature increasing means. One form of a suitable temperature increasing means is a conduit, which is wrapped around the sorptive filter. This conduit could be connected, for example, to either the engine cooling system or to the engine exhaust system in order to utilize at least a portion of the waste heat generated by the engine. Additionally, it may be advantageous in some applications to simply locate the sorptive filter in relatively close proximity to the engine in order to utilize the heat radiated by the engine.

Unfortunately, since the mid-1980's, researchers have not been able to substantially increase the capacity of the adsorbent storage vessels. Even with the use of guard beds, such as described in the above-mentioned patents as sorptive filters, substantial increases in the storage capacity of the sorbent vessels have not increased sufficiently to achieve commercial use of adsorptive natural storage. The prior art has not recognized the sorptive properties of the constituents in the natural gas stream supply to effectively manipulate the pressurization (fueling) and depressurization (throttling) of the power plant to substantially improve the storage capacity of the adsorbent in the storage vessel to allow such means to be used in commercial vehicles. While the afore-mentioned patents describe a manual shut-off valve between the adsorbent storage vessel and the sorptive filter, the patents do not otherwise teach or recognize a manipulation of the system to allow significant decrease in the size of the sorptive filter, and at the same time, vastly increase the capacity of the adsorptive storage vessel.

### SUMMARY OF THE INVENTION

In accordance with the present invention, a natural gas-powered vehicle is provided, which has substantially increased methane storage utilizing a storage vessel which contains a methane adsorbent. In this invention, a sorbent-containing guard bed is provided, along with the primary adsorptive storage vessel. The guard bed is substantially smaller than the primary adsorptive storage vessel, yet the proposed system greatly increases the adsorptive capacity of the primary adsorptive storage vessel by the addition of a valve between the guard bed and the primary storage vessel, to allow optimal pressurization between the two vessels during fueling of the system and depressurization during operation of the engine. Heating of the guard bed during depressurization improves desorption of C₃₊ hydrocarbons and improves adsorptive capacity during refueling.

### BRIEF DESCRIPTION OF THE DRAWINGS

FIG. 1 is a schematic of the adsorption system of the present invention showing a guard bed, a primary adsorption storage bed and a valve between the two sorptive beds.

FIG. 2 is a schematic of the adsorption storage system as in FIG. 1, with the addition of the application of heat to the guard bed.

FIG. 3 is a schematic of an alternative storage system comprising a guard bed and two primary storage beds arranged in series.

FIG. 4 is a schematic of the alternative storage system shown in FIG. 3, with additional heat applied to both the guard bed and first primary storage bed.

FIG. 5 is a schematic showing the operation of the guard bed and primary adsorption storage bed during fueling (pressurization) and throttling (depressurization) of the storage system.

FIG. 6 depicts percentages of heavy hydrocarbon feed adsorbed by the guard bed operating under the condition of the invention.

FIG. 7 depicts percentages of heavy hydrocarbon feed adsorbed by the heated guard bed operating under the conditions of the invention.

### DETAILED DESCRIPTION OF THE INVENTION

Storage systems for gaseous hydrocarbon fuel powered vehicles are known, wherein the natural gas fuel is stored on-board at relatively low pressures up to approximately 500 psig using sorptive storage means. Such systems are disclosed, for example, in U.S. Pat. Nos. 4,522,159 and 4,523,548, discussed previously.

In general, the natural gas storage system comprises means for on-board storage of a self-contained supply of the gaseous hydrocarbon fuel, a prime mover, means for conveying the gaseous hydrocarbon fuel to and from the on-board storing means and means for controlling the pressure of the gaseous hydrocarbon fuel from the on-board storing means to the prime mover. The on-board storing means is said to include one or more vessels or cylinders, containing a predetermined sorbent material for allowing a given amount of the gaseous hydrocarbon fuel to be stored at such lower pressure. The prime mover such as an internal combustion engine includes means for combining the gaseous hydrocarbon fuel with air to produce the mechanical energy therefrom necessary to move the vehicle. The conveying means is reported to be adapted so as to convey the gaseous hydrocarbon fuel to the on-board storing means from a stationary refueling apparatus, and also to convey the gaseous hydrocarbon fuel from the on-board storing means to the combining means of the prime mover during operation of the vehicle. In the preferred embodiment, the maximum pressure at which the gaseous hydrocarbon fuel is stored in the on-board storing means is the range of approximately 100 psig to approximately 600 psig.

The specifics of the prime mover, and connections between the prime mover and the natural gas storage vessel or vessels, as well as the specific fueling supply connections are not part of the present invention and are believed to be known, again, as described in the above-mentioned U.S. patents. The storage system, which forms the basis of the present invention includes a fuel port, a primary storage vessel, and interposed between the fuel port and the primary storage vessel is a sorptive filter or guard bed, which forms an important part of the invention.

Each of the primary storage vessels contain a predetermined sorbent material for reducing the pressure at which the gaseous hydrocarbon fuel is stored within the cylinders. As referred to herein, the terms “sorbent” or “sorptive” are intended to refer to “adsorbents”, “absorbents” or both. The absorbent material may comprise any of a number of adsorbents or molecular sieves, such as activated carbon, zeolite compounds, various clays, silica gels, or metal organic framework (MOF) materials, for example. Such adsorbent materials may be in the form of pellets, spheres, granulated particles, or other suitable forms whereby the surface area of the adsorbent material is optimized in order to maximize the amount of natural gas adsorbed on the surface thereof. The present invention also contemplates the use of liquid absorbents, such as a liquid coating on an adsorbent material.

The guard bed is comprised of a vessel, which contains a predetermined sorbent material for filtering the flow of the gaseous hydrocarbon fuel to the primary storage vessel or vessels. The guard bed may be any shape or construction, which is capable of withstanding the maximum pressure at which the power plant is intended to operate. However, it is generally preferred that the size of the filter vessel be substantially smaller than the size of the primary storage vessel. Specifically, it has been found advantageous to provide the guard bed with at most 60% of the storage capacity of the primary storage vessel, preferably at most 45% of the capacity of the primary storage vessel, more preferably at most 30% of the capacity of the primary storage vessel. By the further application of heat to the guard bed, storage capacity can be at most about 15%, of the storage capacity of the primary storage vessel, can be at most about 13%, of the storage capacity of the primary storage vessel, and can be even further reduced to 5% or less than the storage capacity of the primary storage vessel. With regard to the sorbent material, it is preferred that this sorbent material is comprised of a material having the ability to absorb C₃₊ hydrocarbons. In this regard, both the sorbent material contained in the guard bed and the sorbent material contained in the primary storage vessel may both be comprised of the same or different adsorbent. Examples of adsorbent include, but are not limited to activated carbon, zeolites, silica, metal organic frameworks (MoFs), etc.

It should be noted that the guard bed is associated with the conveying means of the power plant such that the gaseous hydrocarbon fuel supplied by a stationary source thereof must first pass through the guard bed before being stored in the primary storage vessel. Likewise, before the stored gaseous hydrocarbon fuel can be conveyed to a carburetor of the power plant, this fuel must again pass through the guard bed. During the charging of the primary storage vessel, the guard bed adsorptively and/or absorptively removes predetermined constituents of the gaseous hydrocarbon fuel, as well as any odorent previously introduced to the fuel, before the gaseous hydrocarbon fuel is conveyed to the primary storage vessel. These predetermined constituents include, for example, oil, water vapor, and so-called “heavy end”, i.e. C₃₊ hydrocarbon constituents of the fuel. Generally speaking, such heavy end constituents include propane and other constituents that are heavier than methane. The purpose of removing such heavy end constituents is to maximize the capability of the primary storage vessel to sorptively store the lighter hydrocarbons, such as methane for example. It is also important to note that the guard bed also operates to prevent the accumulation over time of any unwanted fuel constituents in the primary storage vessel.

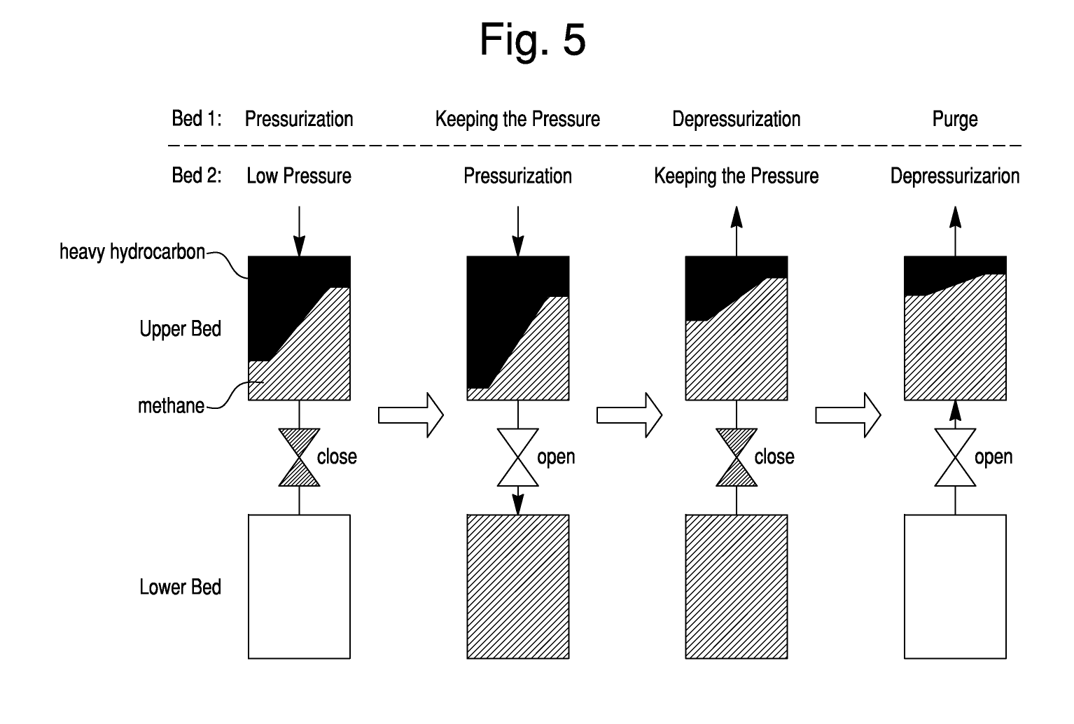

When the engine for the power plant is energized and enabled to consume the gaseous hydrocarbon fuel stored in the storage vessel, the guard bed operates to desorptively re-introduce the removed constituents and odorant to the flow of the gaseous hydrocarbon fuel from the storage vessel to the carburetor of the engine. Accordingly, it should be appreciated that the guard bed is self-cleaning during each charge and discharge cycle of the storage system. Previous to this invention, it was not recognized that the pressurization of the guard bed and the primary storage vessel could be manipulated, so as to optimize the adsorption of the heavier hydrocarbon components in the guard bed, thus, allowing increased methane adsorption capacity in the primary storage vessel. The present inventors recognize that the heavier hydrocarbon components are best adsorbed at higher pressures, and most favorably desorbed at lower pressures. In accordance with this invention, a valve is provided between the guard bed and the primary storage vessel, so as to optimize adsorption of the heavy hydrocarbons during the fueling of the vehicle, and optimize desorption of the heavy hydrocarbons from the guard bed during depressurization and throttling of the engine. The manipulation of the valve between the guard bed and primary storage vessel to provide this optimization during pressurization and depressurization will be described below with respect to FIG. 5.

In order to assist the desorption of the undesirable constituents from the sorbent material contained in the guard bed, means for increasing the temperature of the guard bed are provided in the appropriate application. Preferably, this temperature increasing means is associated with the engine of the power plant so that the heat generated by the operation of the engine is utilized by the temperature increasing means. One form of a suitable temperature increasing means is a conduit, which is wrapped around the guard bed. This conduit could be connected, for example, to either the engine cooling system or to the engine exhaust system in order to utilize at least a portion of the waste heat generated by the engine. Additionally, it may be advantageous in some applications to simply locate the guard bed in relatively close proximity to the engine in order to utilize the heat radiated by the engine. Alternatively, heat can be provided to the guard bed by heat exchange with gas entering the guard bed during depressurization.

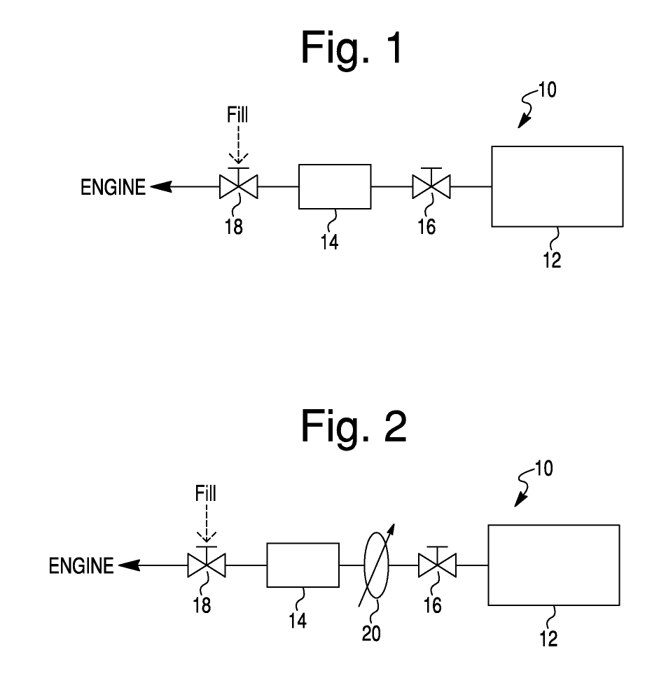

The natural gas storage system of the present invention can now best be explained by referring to the figures. As shown in FIG. 1, natural gas storage system 10 includes a primary storage vessel 12, which contains a particulate adsorbent (not shown), which can adsorb natural gas at elevated pressure. In series with and connected to the primary storage unit 12 is a guard bed 14, which also contains a particulate adsorbent capable of adsorbing natural gas, and, in particular, constituents of a natural gas stream including heavy hydrocarbons, i.e. C₃₊ hydrocarbons. The adsorbents in the primary storage vessel 12 and guard bed 14 may be the same or different. More preferably, the guard bed 14 will contain an adsorbent, which is highly selective to C₃₊ hydrocarbons. For example, silica gel adsorbents are particularly useful in the guard bed. Situated between the primary storage vessel 12 and the guard bed 14 is a valve 16, which allows the differential pressurization and depressurization of vessel 12 and guard bed 14 to maximize the methane storage capacity of the primary storage vessel 12.

In FIG. 1, valve 18 is meant to represent known connection structure, which allows a natural gas powered vehicle to be filled with natural gas from a natural gas source, as well as representing the known connection means from the guard bed 14 to the prime mover or engine to supply the engine with natural gas during throttling of the vehicle. Accordingly, valve 18 is not meant to denote a specific valve, but known connections including piping and manifolds as known in the art. The connection mechanism between the fuel source and the storage system 10 and the connections between the fuel storage system 10 to the engine are not considered part of the present invention, which is intended to be limited to the storage system comprising the combination of guard bed and primary storage vessel or vessels. It is useful that the guard bed 14 be substantially smaller than the primary storage vessel 12 to provide a practical natural gas storage system for a commercial vehicle. By use of the valve 16, the guard bed 14 can be at most 60%, preferably at most 45%, more preferably at most 30% and by the further application of heat to the guard bed, storage capacity thereof can be at most about 15% of the storage capacity of the primary storage vessel 12, can be at most about 13% of the storage capacity of the primary storage vessel 12, and can be even further reduced to 5% or less than the storage capacity of the primary storage vessel 12. As will be explained with respect to FIG. 5, the manipulation of the valve 16 allows the guard bed to be smaller and yet allow increased methane storage capability in the primary storage vessel 12.

FIG. 2 represents a preferred embodiment over FIG. 1 in that the guard bed 14 is provided with a heating mechanism 20 during depressurization of the primary storage vessel 12 and guard bed 14 during throttling of the engine, and the supply of the natural gas thereto. The heating of the guard bed 14 to temperatures ranging from 60° C. to 300° C. greatly facilitates the desorption of the heavy hydrocarbons from the adsorbent therein, which are then burned along with the methane from the natural gas stored in primary storage unit 12 and guard bed 14. The efficient removal of these heavy hydrocarbons from the guard bed 14 allows improved adsorption of these heavy hydrocarbons during refueling of the storage system 10.

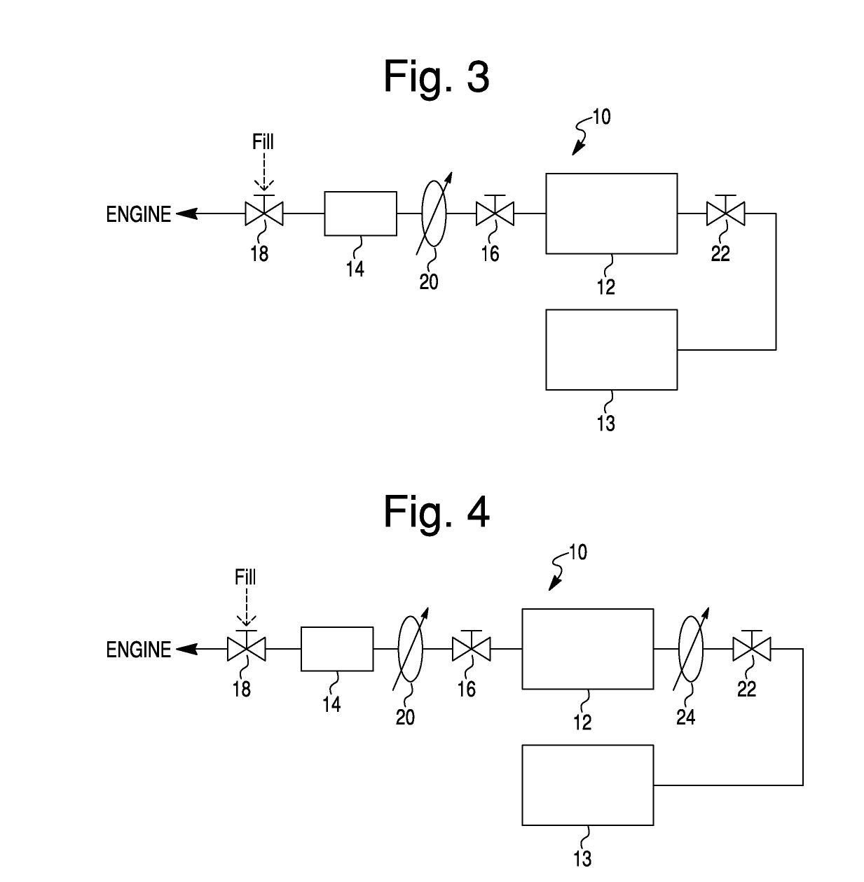

FIG. 3 represents an alternative to the system shown in FIG. 2, in which the storage system 10 includes two primary storage vessels 12 and 13, linked in series with each other and the guard bed 14. Again, located between the guard bed 14 and the first primary storage vessel 12 is valve 16, which can be manipulated to control the individual pressurization and depressurization of primary storage vessel 12 and guard bed 14. Importantly, a valve 22 is placed between the primary storage vessels 12 and 13 to allow differential pressurization and depressurization between these vessels, again, to improve adsorption of the heavier hydrocarbons and improved capacity of methane storage in these vessels. As shown in FIG. 3, heat exchanger 20 is preferably used to heat guard bed 14 during the depressurization to improve the desorption of the heavy hydrocarbons from the adsorbent. As noted previously, the heat exchange as shown in FIGS. 2 and 3 can be that as described previously, in which the heat exchange can be a conduit connected to the engine cooling or exhaust system to utilize at least a portion of the waste heat generated by the engine. The heat exchange could alternatively heat the natural gas stream entering guard bed 14 from primary storage vessel 12 during depressurization.

The storage system 10 shown in FIG. 4 is essentially identical to the system shown in FIG. 3, except that an additional heat exchange system 24 is placed to heat the primary storage vessel 12. Again, the heat provided by exchanger 24 to primary storage vessel 12 is to facilitate the desorption of the methane, as well as the heavy hydrocarbons which may be contained in the sorbent of primary storage vessel 12 to allow more efficient methane storage capacity in vessels 12 and 13 during continuing refuelings. Alternatively, although not shown, the embodiment in FIG. 4 could be achieved without the use of a smaller guard bed 14. In such instance, two or more primary storage vessels 12 and 13 could be placed in series with or without the heat exchanger 24 placed between the two vessels. In this embodiment, valve 22 is manipulated, as will be described below, such that the first primary storage vessel in the chain acts as a guard bed and removes a substantial portion of the heavy hydrocarbons prior to methane storage in the primary storage vessel 13 placed in series therewith. Additional storage vessels could be placed in series or in parallel with the latter primary storage vessels in the series chain.

The operation of the natural gas storage system of this invention can best be described by referring to FIG. 5. The inventors have recognized that the storage capacity for methane can be increased by the optimal adsorption of heavy hydrocarbons in the guard bed. This can only be achieved by adsorbing the heavy hydrocarbons at high pressure. Previous to this invention, the guard bed, in series with the primary storage vessel, were fueled while the two systems were open to each other. While the upstream guard bed may have removed slightly more of the heavy hydrocarbons than the primary storage vessel, the two vessels were essentially at the same pressure and, accordingly, the adsorption of the heavy hydrocarbon was not aided by any pressure differential. In accordance with this invention, a valve placed between the guard bed and primary storage vessel can be manipulated to provide differential pressurization and depressurization of the guard bed and the primary storage vessel or vessels to improve heavy hydrocarbon adsorption in the guard bed, which allows the size of the guard bed to be greatly reduced and at the same time increase the storage capacity of the primary storage vessel for methane. Referring to FIG. 5, “Bed 1” and “Upper Bed” refer to the guard bed 14, as referenced in FIGS. 1-4. The terms “Bed 2” and “Lower Bed” refer to the primary storage vessel 12, referenced in FIGS. 1-4. During fueling of the fuel storage system, valve 16 between the guard bed and the primary storage vessel is closed, allowing pressurization of the guard bed up to about 500 psia. The higher pressure in the guard bed relative to the primary storage vessel during the initial fueling stage enhances the adsorption of the heavy hydrocarbons in the guard bed as shown. Once the guard bed is at the desired pressure, valve 16 can be opened allowing pressurization of the primary storage vessel from the methane in the natural gas stream, as most of the heavy hydrocarbons are adsorbed and trapped within the upstage portion of the guard bed. Once the primary storage vessel is at the desired pressure, the vehicle is then fully fueled and ready for operation. During operation of the vehicle and throttling for movement of the vehicle, valve 16 is again closed and valve and connection 18 is opened, allowing depressurization of the guard bed and desorption of the methane and heavy hydrocarbons, in particular, from the guard bed for combustion in the engine. When the guard bed is at the engine supply pressure, i.e. 50 psia, valve 16 can be opened to allow depressurization of the primary storage vessel, and eventual purging of the guard bed of sustainably all of the heavy carbons therefrom. Depressurization of primary storage vessel 12 is controlled such that the pressure in the guard bed 14 does not increase beyond what is needed to provide necessary flow to the engine. Thus, valve 16 can be opened and closed periodically to achieve the desired depressurization and proper flow to the engine. In this manner, the heavy hydrocarbons are adsorbed at the highest optimal pressure and desorbed at the lowest optimal pressure. To enable the guard bed to be substantially reduced in size, it is likely that the guard bed needs to be heated to improve the desorption of the heavy hydrocarbons from the guard bed during the depressurization cycle.

The operation of the methane storage system 10 as shown in FIG. 4 is essentially the same in that during the filling of the storage system, valves 16 and 22 are closed to initially pressurize the guard bed 14. When the guard bed 14 is at the desired engine supply pressure, valve 16 can be opened, while maintaining valve 22 still in the closed position. This allows primary storage vessel 12 to act as a secondary guard bed and adsorb any heavy hydrocarbons from the natural gas stream being fueled into the system, and which are not fully adsorbed in guard bed 14. Once the primary storage vessel 12 is at the desired pressure, valve 22 can be opened and primary storage vessel 13 pressurized with methane. It is believed that very little of the heavy hydrocarbon content in the natural gas fuel stream will be contained in the primary storage vessel 13, due to adsorption in guard bed 14 and primary storage vessel 12. Throttling of the engine and depressurization of the storage system again operates as previously described, in which initially valve 16 is closed and the guard bed 14 is allowed to depressurize. When the guard bed 14 is at the engine supply pressure, valve 16 is opened to depressurize primary storage vessel 12. Valve 16 is controlled so that the pressure does not increase in guard bed 14 beyond that what is needed to provide necessary flow to the engine. This can be achieved by opening and closing valve 16 periodically. Valve 22 can now be opened to depressurize the primary storage vessel 13. Initially, during depressurization of the guard bed 14 and primary storage vessel 12, heat can be supplied by the respective heat exchange means 20 and 24 to improve and increase the desorption of natural gas and, in particular, the heavy hydrocarbons from the adsorbent in primary storage vessel 12 and guard bed 14.

### EXAMPLE 1

Two natural gas storage systems as shown in FIG. 1 were tested, wherein a first system contained a guard bed having 30% of the capacity of an empty primary storage vessel that is sized to have equivalent gas capacity of an adsorbent filled tank (24 liters of 80 liters), and a second system contained a guard bed having 45% of the capacity of the primary storage vessel (36 liters of 80 liters). For both systems the guard beds included Sorbead H® from BASF as the asdorbent material.

For the first system, a supply of natural gas was sent to an opened connection 18 at a pressure of 600 psia to a guard bed 14 to pressurize the guard bed 14 from 60 to about 515 psia. During the pressurization of the guard bed 14, valve 16 was closed to retain primary storage tank 12 at 60 psia. As the pressure within guard bed 14 reached 515 psia, valve 16 was opened to pressurize primary storage vessel 12 to about 515 psia to store filtered natural gas from guard bed 14. During the engine acceleration process, connection 18 was opened to depressurize guard bed 14 from 515 psia to the same pressure as the engine, about 60 psia. During the depressurization, valve 16 was closed to maintain primary storage vessel at about 500 psia. As guard bed 14 reached about 60 psia, valve 16 was opened to depressurize primary storage tank 12, allowing filtered natural gas to flow toward and to purge guard bed 14.

The above-mentioned process was repeated as 30 cycles, and during the last accelerating cycle, amounts of C4, C5 and C6 hydrocarbons were collected from the filtered gas exiting storage tank 12. The amounts of hydrocarbons were compared with the amounts of C4, C5 and C6 hydrocarbons gathered in the initial fueling of the first cycle from connection 18.

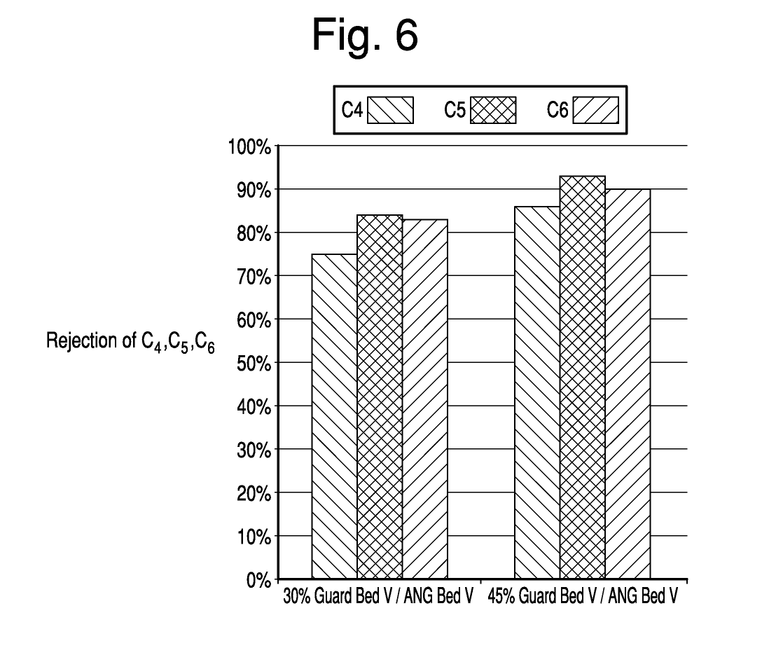

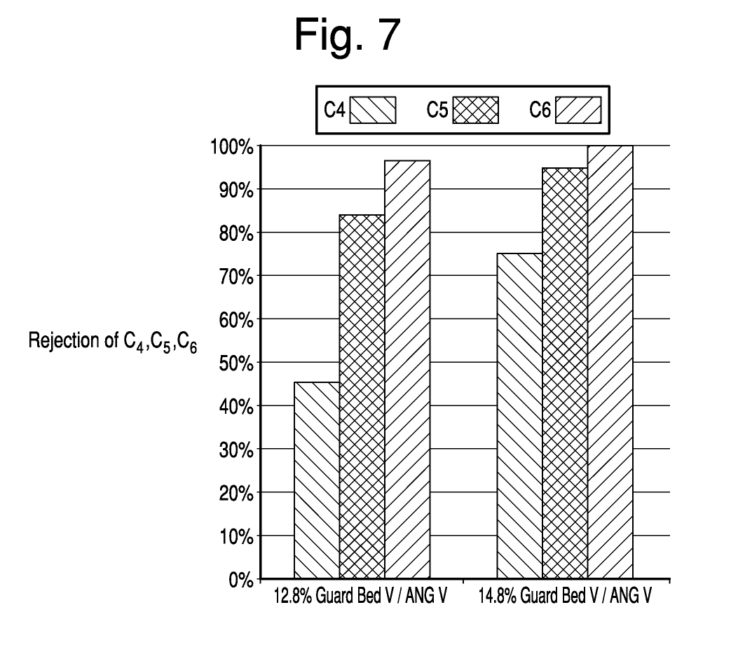

As shown in FIG. 6, the natural gas storage system with the guard bed having 30% of capacity of the primary storage vessel adsorbed or rejected from the connection supply, about 75% of the C₄ hydrocarbons, and at least 80% of the C₅ and C₆ hydrocarbons. Meanwhile, the natural gas storage system with the guard bed having 45% of capacity of the primary storage vessel adsorbed at least 85% of the C₄ hydrocarbons, and at least 90% of the C₅ and C₆ hydrocarbons.

### EXAMPLE 2

Two natural gas storage systems as shown in FIG. 2 were tested, wherein the first system contained a guard bed having 12.8% of the capacity of an empty primary storage vessel that is sized to have equivalent capacity of an adsorbent filled tank (10.24 liters of 80 liters), and a second system contained a guard bed having 14.8% of the capacity of the primary storage vessel (11.84 liters of 80 liters). For both systems the guard beds included Sorbead H® from BASF as the adsorbent material.

A supply of natural gas was sent to an opened connection 18 at 600 psia to a guard bed 14 to pressurize the guard bed 14 from 60 to about 515 psia. During the pressurization of guard bed 14, valve 16 was closed to retain primary storage tank 12 at 60 psia. As the pressure within guard bed 14 reached 515 psia, valve 16 was opened to pressurize primary storage vessel 12 to about 515 psia to store filtered natural gas from guard bed 14. During the engine acceleration process, connection 18 was opened to depressurize guard bed 14 from 515 psia to the same pressure as the engine, about 60 psia. During the depressurization, valve 16 was closed to maintain primary storage vessel at about 500 psia. As guard bed 14 reached about 60 psia, a heating mechanism 20 heated guard bed 14 to about 80° C., then valve 16 was opened to depressurize primary storage tank 12, allowing filtered natural gas to flow toward and to purge guard bed 14.

The above-mentioned process was repeated as 30 cycles, and during the last accelerating cycle, amounts of C4, C5 and C6 hydrocarbons were collected from the filtered gas exiting storage tank 12. The amounts of hydrocarbons were compared with the amounts of C4, C5 and C6 hydrocarbons gathered in the initial fueling of the first cycle from connection 18.

As shown in FIG. 6, the natural gas storage system with the guard bed having 12.8% of capacity of the primary storage vessel adsorbed or rejected from the connection supply, about 45% of the C₄ hydrocarbons, at least 80% of the C₅ hydrocarbons and at least 95% of the C₆ hydrocarbons. Meanwhile, the natural gas storage system with the guard bed having 14.8% of capacity of the primary storage vessel adsorbed at least 75% of the C₄ hydrocarbons, and at least 95% of the C₅ and C₆ hydrocarbons.

1. A natural gas storage system comprising: 1) a guard bed containing a particulate adsorbent for adsorbing heavy hydrocarbons from a natural gas feed; 2) a primary storage vessel containing a particulate adsorbent for adsorbing natural gas and in communication with said guard bed; and 3) at least one valve interposed between said guard bed and said primary storage vessel to control follow of gas from said guard bed to said primary storage vessel, wherein said guard bed is smaller than said primary storage vessel.

2. The natural gas storage system of claim 1, wherein said guard bed has at most 60% of the gaseous storage capacity of said primary storage vessel.

3. The natural gas storage system of claim 2, wherein said guard bed has at most 30% of the gaseous storage capacity of said primary storage vessel.

4. The natural gas storage system of claim 1, wherein said guard bed and/or said primary storage vessel contains an adsorbent selected from the group consisting of activated carbon, zeolites, silica gels, clays, metal organic frameworks (“MoFs”) and mixtures thereof.

5. The natural gas storage system of claim 1, wherein said guard bed adsorbs at least one constituent selected from the group consisting of oil, water vapors, C₃₊ hydrocarbons and mixtures thereof.

6. The natural gas storage system of claim 1, wherein said guard bed is in communication with a fuel port and an engine.

7. The natural gas storage system of claim 1, wherein said guard bed includes a heating mechanism.

8. The natural gas storage system of claim 7, wherein said guard bed has at most about 15% of the gaseous storage capacity of said primary storage vessel.

9. The natural gas storage system of claim 8, wherein said guard bed has at most 13% of the gaseous storage capacity of said primary storage vessel.

10. The natural gas storage system of claim 1, wherein said system further includes a second fuel storage vessel in communication with said primary storage vessel, and a second valve interposed between said primary storage vessel and said second storage vessel to control gas flow between said primary storage vessel and said second fuel storage vessel.

11. The natural gas storage system of claim 10, wherein said primary storage vessel further includes a heating mechanism.

12. A method of fueling a vehicle powered by natural gas, comprising: 1) providing a natural gas storage system comprising: a) a guard bed containing a particulate adsorbent for adsorbing heavy hydrocarbons from a natural gas feed; b) a primary storage vessel containing a particulate adsorbent for adsorbing natural gas and in communication with said guard bed; and c) at least one valve interposed between said guard bed and said primary storage vessel to control follow of gas from said guard bed to said primary storage vessel, wherein said guard bed is smaller than said primary storage vessel; 2) closing said valve; 3) supplying natural gas into said guard bed when said valve is closed to pressurize said guard bed, and to retain said primary storage vessel at a pressure lower than said guard bed; and 4) opening said valve when said guard bed is adequately pressurized to allow gas flow from said guard bed to said primary storage vessel to pressurize said primary storage vessel, and to fill said primary storage vessel with filtered natural gas.

13. The method of claim 12, wherein said guard bed and said primary storage vessel contains an adsorbent selected from the group consisting of activated carbon, zeolites, silica gels, clays, metal organic frameworks (“MoFs”) and mixtures thereof.

14. The method of claim 12, wherein said guard bed in step 3) adsorbs at least one constituent selected from the group consisting of oil, water vapors, C₃₊ hydrocarbons, odorants and mixtures thereof.

15. The natural gas storage system of claim 12, wherein said guard bed has at most 45% of the gaseous storage capacity of said primary storage vessel.

16. The method of claim 12, further comprising: 5) providing a second storage vessel in communication with said primary storage vessel, and a second valve interposed between said primary storage vessel and said second storage vessel to control gas flow between said primary storage vessel and said second fuel storage vessel; 6) closing said second valve during step 4) to pressurize said primary storage vessel, and to retain said second storage vessel at a lower pressure than said primary storage vessel; and 7) opening said second valve when said primary storage vessel is adequately pressurized to allow gas flow from said pressure storage valve to said second storage vessel to pressurize said second storage vessel and to fill said second storage vessel with filtered natural gas.

17. A method of accelerating an engine of a vehicle powered by natural gas, comprising: 1) providing a natural gas storage system comprising: a) a guard bed containing a particulate adsorbent for adsorbing heavy hydrocarbons from natural gas feed; b) a primary storage vessel containing a particulate adsorbent for adsorbing natural gas and in communication with said guard bed; c) and at least one valve interposed between said guard bed and said primary storage vessel to control follow of gas from said guard bed to said primary storage vessel, wherein said guard bed is smaller than said primary storage vessel; 2) closing said valve; 3) opening a connection interposed between said guard bed and said engine to depressurize said guard bed when said valve is closed; and 4) opening said valve when said guard bed is adequately depressurized to allow gas flow from said primary storage vessel to said guard bed to depressurize said primary storage vessel, and enable flow of filtered natural gas from said primary storage vessel through said guard bed into said engine.

18. The method of claim 17, wherein said guard bed has at most about 15% of the gaseous storage capacity of said primary storage vessel.

19. The natural gas storage system of claim 18, wherein said guard bed further includes a heating mechanism.

20. The natural gas storage system of claim 19, wherein said heating mechanism heats said guard bed to a temperature ranging from 60° C. to 300° C. during at least step 3).
